(19) United States
(12) Patent Application Publication
(10) Pub. No.: US 2006/0166088 A1
(43) Pub. Date: Jul. 27, 2006

(54) Electrode connector tabs

(76) Inventors: Karl E. Hokanson, Coon Rapids, MN (US); Joseph J. Viavattine, Vadnais Heights, MN (US)

Correspondence Address: MEDTRONIC, INC., 710 MEDTRONIC PARK, MINNEAPOLIS, MN, 55432-9924, US

(21) Appl. No.: 11/043,583

(22) Filed: Jan. 26, 2005

(51) Int. Cl. H01M 2/26; H01M 2/06

(52) U.S. Cl. 429/161; 429/211; 429/181

(57) ABSTRACT

Embodiments of the invention provide electrochemical cells for use in implantable medical devices. Embodiments of the invention provide an anode or cathode with a connection tab or tabs that extend a sufficient distance from separation material between the anode and cathode to reduce the heat transferred back to the separation material when the tab is electrically connected to the battery case, cover, or feedthrough pin.

### FIELD OF THE INVENTION

The disclosure relates generally to the field of electrode connector tabs for applications such as within batteries for implantable medical devices.

### BACKGROUND SECTION

Implantable medical devices provide therapies to patients suffering from a variety of conditions. Examples of implantable medical devices are implantable pacemakers and implantable cardioverter-defibrillators (ICDs), which are electronic medical devices that monitor the electrical activity of the heart and provide electrical stimulation to one or more of the heart chambers, when necessary. For example, pacemakers are designed to sense arrhythmias and in turn, provide appropriate electrical stimulation pulses, at a controlled rate, to selected chambers of the heart in order to correct the arrhythmias and restore the proper heart rhythm. The types of arrhythmias that may be detected and corrected by pacemakers include bradycardias, which are unusually slow heart rates, and certain tachycardias, which are unusually fast heart rates.

Implantable cardioverter-defibrillators (ICDs) also detect arrhythmias and provide appropriate electrical stimulation pulses to selected chambers of the heart to correct the abnormal heart rate. In contrast to pacemakers, however, an ICD can also provide pulses that are much stronger and less frequent. This is because ICDs are generally designed to correct fibrillationand severe tachycardias. To correct such arrhythmias, ICDs deliver low, moderate, or high-energy therapy to the heart.

Pacemakers and ICDs are preferably designed with shapes that are easily adapted to the patient's body while minimizing patient discomfort. As a result, the corners and edges of the devices are typically designed with generous radii to present a package having smoothly contoured surfaces. It is also desirable to minimize the volume and mass of the devices to further limit patient discomfort.

The electrical energy for the shocks delivered by ICDs is generated by delivering electrical current from a power source (battery) to charge capacitors with stored energy. The capacitors are capable of rapidly delivering that energy to the patient's heart. In order to provide timely therapy to the patient after the detection of ventricular fibrillation, for example, it is necessary to charge the capacitors with the required amount of energy as quickly as possible. Thus, the battery in an ICD must have a high rate capability to provide the necessary current to charge the capacitors. In addition, since ICDs are implanted in patients, the battery must be able to accommodate physical constraints on size and shape.

Batteries or cells are volumetrically constrained systems. The sizes or volumes of components that are contained within a battery (cathode, anode, separator, current collectors, electrolyte, etc.) cannot in total exceed the available volume of the battery case. The arrangement of the components affects the amount or density of active electrode material which can be contained within the battery case.

Conventional lithium batteries can employ an electrode configuration sometimes referred to as the “jelly roll” design, in which anode, cathode and separator elements are overlaid and coiled up in a spiral wound form. A strip sheet of lithium or lithium alloy comprises the anode, a cathode material supported on a charge collecting metal screen comprises the cathode, and a sheet of non-woven material separates the anode and cathode elements. These elements are combined and wound to form a spiral. Typically, the internal battery configuration for such a wound electrode is pressed into a substantially prismatic case or enclosure. An advantage of this design is no more anode material is needed than what is mated to cathode material in the jelly roll electrode configuration. Such designs therefore have the potential for an improved match between the cathode and anode components and improved uniformity of anode and cathode utilization during discharge.

In designing batteries for implantable medical devices, there is generally a desire to minimize battery size/volume. However, certain elements of the battery (e.g., battery component size) cause the battery to be at least a certain size/volume. In addition, if any changes are made to these elements of the battery, the size/volume of the battery can be undesirably increased. As such, it is desirable to provide apparatus and methods that enable changes to made to certain elements of the battery while still limiting the overall size/volume of the battery.

### BRIEF SUMMARY OF THE INVENTION

Embodiments of the invention provide electrochemical cells for use in implantable medical devices. Further, embodiments of the invention provide an anode or cathode with a connection tab or tabs that extend a sufficient distance from separation material between the anode and cathode to reduce the heat transferred back to the separation material when the tab is electrically connected to the battery case, cover, or feedthrough pin.

In some embodiments, the electrochemical cell includes a separator positioned between an anode and a cathode, a battery case having an open end and holding an electrolyte, the anode, and cathode, and the separator, a battery cover hermetically sealed to the battery case, and a feedthrough pin. The cell also includes multiple tabs having a first portion that extends from either the anode or the cathode. The first portion of these tabs are electrically connected together. One of the multiple tabs also has a second portion that extends away from the first portions of the tabs. The second portion of this tab is welded to the battery case, the battery cover, or the feedthrough pin.

In some embodiments, the first portions of the tabs extend in a first direction and the second portion of the one tab extends in a different direction. The directions may differ by between about 45 degrees and 135 degrees or by between about 75 degrees and 105 degrees. In some embodiments, the anode and/or the cathode are formed of multiple electrode plates. In some embodiments, the multiple electrode plates of the anode and cathode are stacked in alternating sequence. In some embodiments, the anode and/or the cathode are formed of a single electrode plate. The single electrode plates of the anode and cathode may be rolled together in a jellyroll style winding.

In other embodiments, the electrochemical cell includes a battery case having an open end and a headspace and holding an electrolyte, an anode, a cathode, and a separator. The anode and cathode are each formed of at least one electrode plate, and the separator is positioned between the anode and cathode electrode plates. The cell also includes a battery cover hermetically sealed to the battery case and a feedthrough pin. A tab extends into the headspace from the plate of either the anode or cathode. The tab has first and second portions that extend in different directions. The first portion extends in one direction from the plate generally towards the top end of the headspace and the second portion extends in a second direction from the first portion. The second portion is welded to either the battery case, the battery cover, or the feedthrough pin.

In some embodiments, the second portion extends no closer to the top end of the headspace than the extension of the first portion. In some embodiments, the first portion extends in the first direction a first distance, the second portion extends in the second direction a second distance, and the second distance is greater than the first distance. In some embodiments, the anode and/or the cathode are formed from a single electrode plate. In some embodiments, the tab is L-shaped or Z-shaped.

In some embodiments, the cell further includes another tab that extends from the anode or cathode plate into the headspace, and the at least one more tab is electrically connected to the first portion of the first tab.

### BRIEF DESCRIPTION OF THE DRAWINGS

FIG. 1 is a simplified schematic view of an exemplary implantable medical device (IMD) incorporating an electrochemical cell in accordance with certain embodiments of the invention;

FIG. 2 is an exploded perspective view of an IMD without cover in accordance with certain embodiments of the invention;

FIG. 3 is a cutaway perspective view of a battery in accordance with certain embodiments of the invention;

FIG. 4 is a partial cross section of an electrode assembly of the battery of FIG. 3;

FIG. 5 is an exploded perspective view of the battery of FIG. 3;

FIG. 6 is an exploded perspective view of a battery in accordance with certain embodiments of the invention;

FIG. 7 is a perspective view of a stacked plate electrode in accordance with certain embodiments of the invention;

FIG. 8A is a plan view of an electrode plate in accordance with certain embodiments of the invention;

FIG. 8B is an enlarged sectional view of a portion of FIG. 8A;

FIG. 9 is a plan view of an electrode plate in accordance with certain embodiments of the invention; and

FIG. 10 is a plan view of an electrode plate in accordance with certain embodiments of the invention.

### DETAILED DESCRIPTION OF THE ILLUSTRATED EMBODIMENTS

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

The present invention is not limited to any one type of application for batteries. For example, while embodiments are described and shown herein illustrating batteries in medical devices with respect to medical applications, the present invention should not be limited as such.

However, when applied to medical applications, the batteries herein should not be limited to any one type of medical device, implantable or otherwise. Instead, if applied in medical technologies, the present invention can be employed in many various types of electronic and mechanical devices designed to have a minimum device volume, for example, in medical devices for treating patient conditions such as pacemakers, defibrillators, neurostimulators, and therapeutic substance delivery pumps. It is to be further understood that the present invention is not limited to high current batteries and may be utilized for low or medium current batteries. For purposes of illustration though, the present invention is below described in the context of high current batteries.

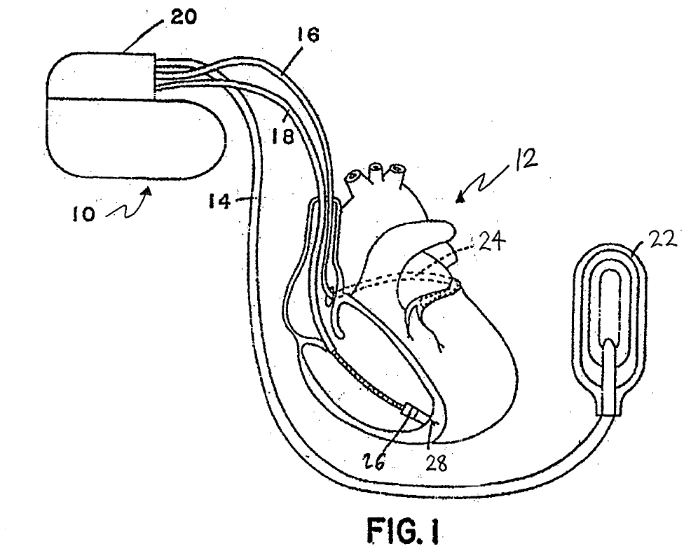

FIG. 1 is a simplified schematic view of an implantable medical device (“IMD”) 10. The IMD 10 is shown in FIG. 1 as a pacemaker/cardioverter/defibrillator (PCD) with a relationship to a human heart 12. However, the IMD 10 shown may assume a wide variety of forms. For example, the IMD 10 may be an implantable cardiac defibrillator (ICD as is known in the art). Alternatively, or in addition, the IMD 10 may be an implantable cardiac pacemaker, such as that disclosed in U.S. Pat. No. 5,158,078 to Bennett et al.; U.S. Pat. No. 5,312,453 to Shelton et al.; or U.S. Pat. No. 5,144,949 to Olson, all hereby incorporated by reference, each in its entirety. Even further, the IMD 10 may be an implantable neurostimulator, such as that described, for example, in U.S. Pat. No. 5,342,409 to Mullet; or an implantable drug pump; a cardiomyostimulator; a biosensor; and the like.

The IMD 10 includes associated electrical leads 14, 16 and 18, although it should be appreciated that the IMD 10 can include any number of leads suitable for a particular application. The leads 14, 16 and 18 are coupled to the IMD 10 by means of a multi-port connector block 20, which contains separate ports for each of the leads 14, 16, and 18. Lead 14 is coupled to a subcutaneous electrode 22, which is intended to be mounted subcutaneously in a subcutaneous location (e.g., a pectoral region of the chest). Alternatively, an active “can” may be employed. Lead 16 is a coronary sinus lead employing an elongated coil electrode 24 that is located in the coronary sinus and great vein region of the heart 12. The location of this elongated coil electrode 24 is illustrated in broken line format in FIG. 1, and extends around the heart 12 from a point within the opening of the coronary sinus to a point in the vicinity of the left atrial appendage. Lead 18 is also provided with an elongated electrode coil 26, which is located in the right ventricle of heart 12. Lead 18 also includes a helical stimulation electrode 28, which takes the form of an advanceable helical coil that is screwed into the myocardial tissue of the right ventricle. Lead 18 may also include one or more additional electrodes for near and far field electrogram sensing.

In the system illustrated, cardiac pacing pulses are delivered between the helical electrode 28 and the elongated electrode 26. The electrodes 26 and 28 are also employed to sense electrical signals indicative of ventricular contractions. As illustrated, the right ventricular electrode 26 can generally serve as the common electrode during sequential and simultaneous pulse multiple electrode defibrillation regimens. For example, during a simultaneous pulse defibrillation regimen, pulses can simultaneously be delivered between electrode 26 and electrode 22, and between electrode 26 and electrode 24. During sequential pulse defibrillation, pulses can be delivered sequentially between subcutaneous electrode 22 and electrode 26, and between coronary sinus electrode 24 and electrode 26. Single pulse, two electrode defibrillation pulse regimens may also be provided, typically between electrode 26 and coronary sinus electrode 24. Alternatively, single pulses may be delivered between electrodes 26 and 22. The particular interconnection of the electrodes to the IMD 10 will generally depend on which specific single electrode pair defibrillation pulse regimen is likely to be employed.

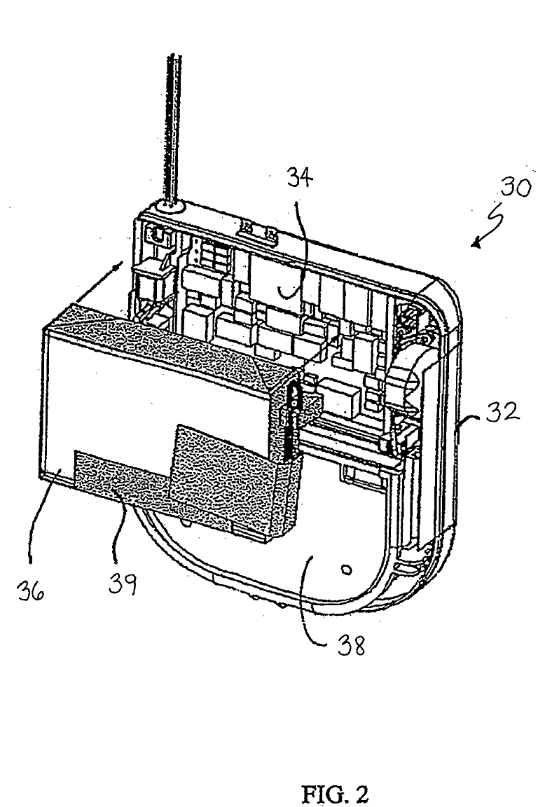

As previously described, the IMD 10 can assume a wide variety of forms as are known in the art. Generally, IMDs include one or more of the following elements: (a) a device housing (e.g., a case), (b) one or more capacitors disposed within the device housing, (c) a battery disposed within the device housing and operatively connected to the capacitor, and (d) circuitry disposed within the device housing providing electrical connection between the battery and the capacitor. Exemplary illustrations and general locations of such elements in an IMD 30 are shown in FIG. 2. As shown, the IMD 30 includes a case 32 (the device housing), an electronics module 34 (the circuitry), an electrochemical cell 36 (the battery), and capacitor(s) 38. Each of these components of the IMD 30 is preferably configured for one or more particular end-use applications. For example, the electronics module 34 is configured to perform one or more sensing and/or stimulation processes. The electrochemical cell 36 provides the electrical energy to charge and re-charge the capacitor(s) 38, and to also power the electronics module 34. The electrochemical cell 36 generally includes an insulator 39 disposed therearound.

Electrochemical cells generally include one or more of the following components: (a) an electrode assembly including one or more of an anode and a cathode, (b) an electrolyte, and (c) a housing within which the electrode assembly and the electrolyte are disposed. In certain embodiments, the housing includes one or more of the following elements: (a) a cover, (b) a case with an open top to receive the cover, (c) at least one feedthrough assembly providing electrical communication from a first electrode of the electrode assembly and the implantable medical device circuitry (e.g., the electronics module 34), (d) a coupling providing electrical connection between the at least one feedthrough assembly and the first electrode of the electrode assembly, and (e) a coupling providing electrical connection between the case (or another feedthrough assembly) and a second electrode of the electrode assembly. The housing further contains one or more insulators including (a) a cover insulator adjacent to the cover providing a barrier between the electrode assembly and the cover, (b) a case insulator adjacent to the case providing a barrier between the electrode assembly and the case, and (c) a headspace insulator adjacent to the electrode assembly (e.g., proximate to the insulator adjacent to the cover) providing a barrier between the electrode assembly and the case.

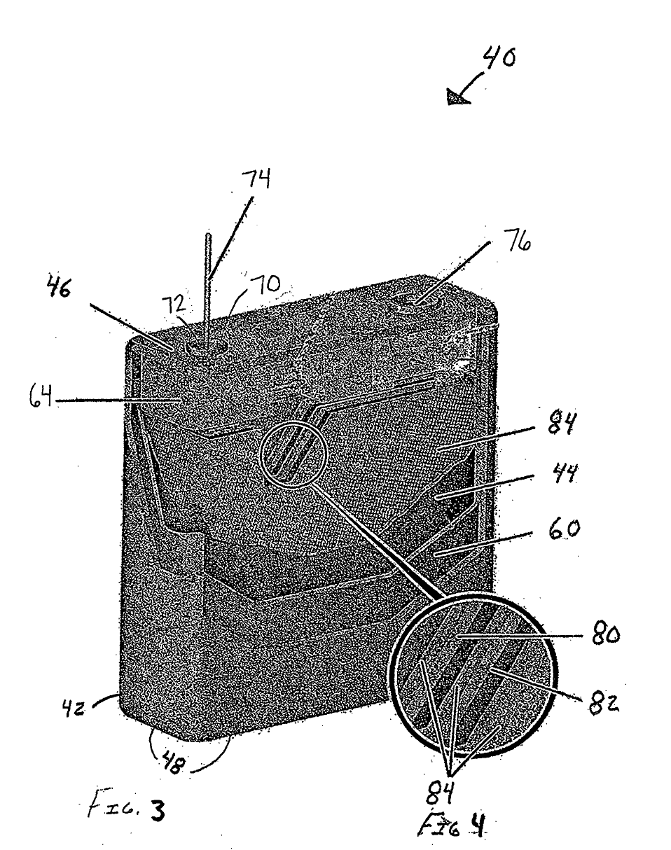

FIG. 3 illustrates a cutaway perspective view of a battery or electrochemical cell in accordance with an exemplary embodiment of the present invention. A battery 40 is illustrated having a long drawn battery case 42 and an electrode assembly 44. The battery case 42 is generally made of a medical grade titanium; however, it is contemplated that the case 42 could be made of almost any type of metal such as aluminum and stainless steel, as long as the metal is compatible with the battery's chemistry in order to prevent corrosion. Further, it is contemplated the battery case 42 can be manufactured from most any processes including but not limited to machining, casting, drawing, or metal injection molding. The battery case 42 is designed to enclose the electrode assembly 44 and be sealed with a battery cover 46. While sides 48 of the battery case 42 are generally planar, it is contemplated the sides 48 could be generally arcuate in shape. This construction would provide a number of advantages including the ability to accommodate one of the curved or arcuate ends of the electrode assembly 44 (e.g., if the assembly 44 were coiled). Arcuate sides could also nest within an arcuate edge of an implantable medical device, such as an implantable cardiac defibrillator.

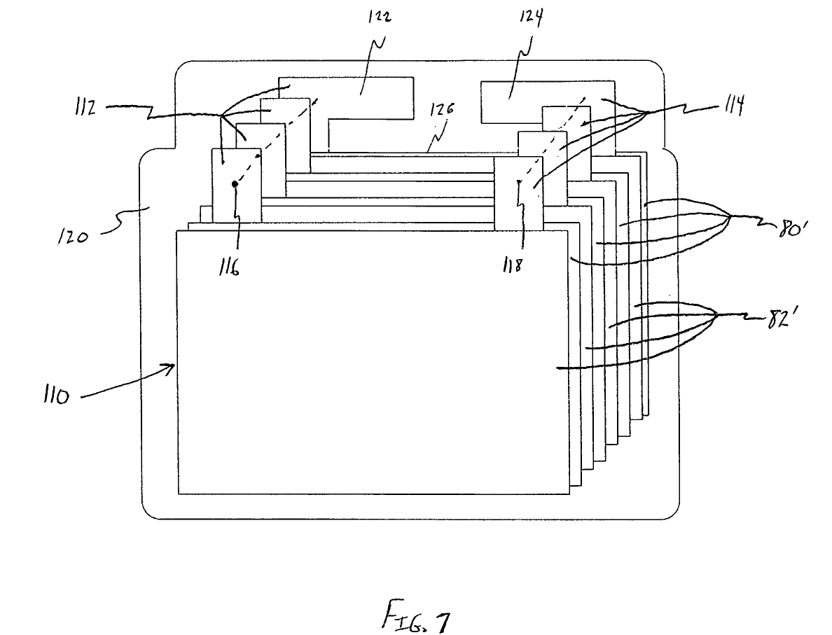

FIG. 6 shows an exploded perspective view of a battery 90 in accordance with an exemplary embodiment of the present invention. The battery 90 is illustrated having a shallow drawn battery case 92 and an electrode assembly 94. Other elements shown include a battery case liner 96 (within battery case 92, not visibly shown), an insulator 98, a battery cover 100, a coupling 102, a headspace cover 104, and a feedthrough assembly 106. The battery case 92 is designed to enclose the electrode assembly 94 and be sealed with the battery cover 100. In certain embodiments, the electrode assembly 94 is hermetically sealed within the battery 90.

As used herein, the terms battery or batteries include a single electrochemical cell or multiple cells and include both primary and secondary cells. Batteries are volumetrically constrained systems in which the components of the battery cannot exceed the available volume of the battery case. Furthermore, the relative amounts of some of the components can be important to provide the desired amount of energy at the desired discharge rates. A discussion of the various considerations in designing the electrodes and the desired volume of electrolyte needed to accompany them in, for example, a lithium/silver vanadium oxide (Li/SVO) battery, is provided in U.S. Pat. No. 5,458,997 (Crespi et al.) the contents of which are hereby incorporated herein. Generally, however, the battery must include the electrodes and additional volume for the electrolyte required to provide a functioning battery. In certain embodiments, the battery is hermetically sealed.

In certain embodiments, the batteries are directed to high current batteries that are capable of charging capacitors with the desired amount of energy in the desired amount of time. In certain embodiments, the desired amount of energy is typically at least about 20 joules. Further embodiments involve the energy amount being about 20 joules to about 40 joules. In certain embodiments, the desired amount of time is no more than about 20 seconds. Further embodiments involve the desired amount of time being no more than about 10 seconds. These energy and time values can typically be attained during the useful life of the battery as well as when the battery is new. As a result, in certain embodiments, the batteries typically deliver up to about 5 amps at about 1.5 to about 2.5 volts, in contrast to low rate batteries that are typically discharged at much lower currents. Furthermore, the batteries are able to provide these amounts of energy repeatedly. In certain embodiments, the battery can provide these amounts of energy with a time delay of no more than about 30 seconds. Further embodiments involve the time delay being no more than about 10 seconds.

The details regarding construction of the electrode assemblies 44 and 94 of FIGS. 3 and 6 respectively, with respect to electrodes and additional elements, are generally described below. The electrode assemblies 44 and/or 94 can be wound or coiled structures similar to those disclosed in, e.g., U.S. Pat. No. 5,486,215 (Kelm et al.). The electrode assemblies 44 and/or 94 can also be part of batteries in which the electrode types include spirally-wound, stacked plate, or serpentine, as disclosed, for example, in U.S. Pat. Nos. 5,312,458 and 5,250,373 to Muffuletto et al. for “Internal Electrode and Assembly Method for Electrochemical Cells;” U.S. Pat. No. 5,549,717 to Takeuchi et al. for “Method of Making Prismatic Cell;” U.S. Pat. No. 4,964,877 to Kiester et al. for “Non-Aqueous Lithium Battery;” U.S. Pat. No. 5,147,737 to Post et al. for “Electrochemical Cell With Improved Efficiency Serpentine Electrode;” and U.S. Pat. No. 5,468,569 to Pyszczek et al. for “Use of Standard Uniform Electrode Components in Cells of Either High or Low Surface Area Design,” the disclosures of which are hereby incorporated by reference herein in their respective entireties. Alternatively, in certain embodiments, the batteries 40 and 90 of FIGS. 3 and 6 respectively, and/or electrochemical cell 54 of FIG. 2, can include single cathode electrodes as described, for example, in U.S. Pat. No. 5,716,729 to Sunderland et al. for “Electrochemical Cell,” which is hereby incorporated by reference in its entirety. The composition of the electrode assemblies 44 and 94 can vary. An exemplary electrode assembly includes a wound core of lithium/silver vanadium oxide (Li/SVO) battery as discussed in, e.g., U.S. Pat. No. 5,458,997 (Crespi et al.). Other battery chemistries are also anticipated, such as those described in U.S. Pat. No. 5,180,642 (Weiss et al) and U.S. Pat. Nos. 4,302,518 and 4,357,215 (Goodenough et al).

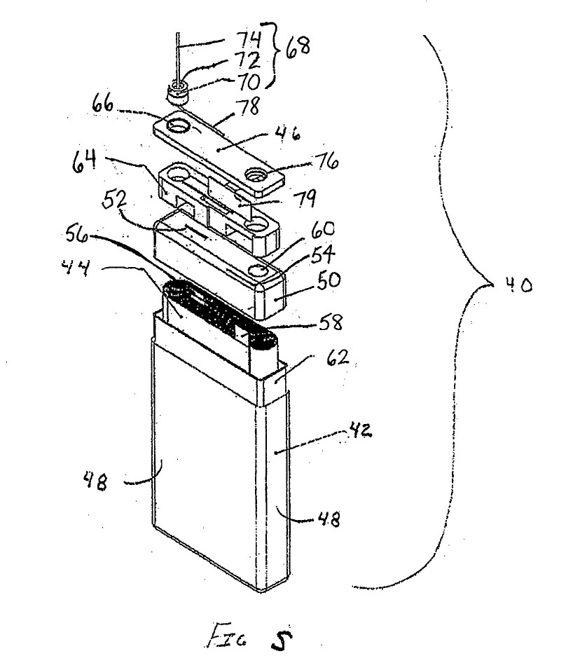

With reference to FIG. 3, a partial cutaway perspective view of the electrode assembly 44 of the battery 40 is shown in FIG. 4. As illustrated, the electrode assembly 44 generally includes a second electrode 80, a first electrode 82, and a porous, electrically non-conductive separator material 84 encapsulating either one or both of the second electrode 80 and the first electrode 82. These three components are generally placed together to form the electrode assembly 44.

The second electrode 80 of the electrode assembly 44 can comprise a number of different materials. Generally, the second electrode 80 includes a second electrode active material located on a second electrode conductor element. In certain embodiments, the second electrode 80 is an anode in the case of a primary cell or the negative electrode in the case of a rechargeable cell. Examples of suitable materials for such anode or negative electrode include, but are not limited to, stainless steel, nickel, or titanium. Examples of suitable second electrode active materials include, but are not limited to, alkali metals, materials selected from Group IA of the Periodic Table of Elements, including lithium, sodium, potassium, etc., and their alloys and intermetallic compounds including, e.g., Li—Si, Li—B, and Li—Si—B alloys and intermetallic compounds, insertion or intercalation materials such as carbon, or tin-oxide.

The first electrode 82 of the electrode assembly 44 generally includes a first electrode active material located on a first electrode current collector. In certain embodiments, the first electrode 82 is a cathode in the case of a primary cell or the positive electrode in the case of a rechargeable cell, and enables the flow of electrons between the first electrode active material and first electrode terminals of the electrode assembly 44. Generally, the cathode or positive electrode comprises a mixed metal oxide formed by chemical addition, reaction or otherwise intimate contact or by thermal spray coating process of various metal sulfides, metal oxides or metal oxide/elemental metal combinations. Generally, such mixed metal oxides will correspondingly contain metals and oxides of Groups IB, IIB, IIIB, IVB, VB, VIB, VIIB, and VIII of the Periodic Table of Elements, which includes noble metals and/or their oxide compounds. The first electrode active materials can include, but are not limited to, a metal oxide, a mixed metal oxide, a metal, and combinations thereof. Suitable first electrode active materials include, but are not limited to, silver vanadium oxide (SVO), copper vanadium oxide, copper silver vanadium oxide (CSVO), manganese dioxide, titanium disulfide, copper oxide, copper sulfide, iron sulfide, iron disulfide, and fluorinated carbon, and mixtures thereof, including lithiated oxides of metals such as manganese, cobalt, and nickel. First cathode and positive electrode materials can also be provided in a binder material such as a fluoro-resin powder; generally polyvinylidine fluoride or polytetrafluoroethylene (PTFE) powder also includes another electrically conductive material such as graphite powder, acetylene black powder, and carbon black powder. In some cases, however, no binder or other conductive material is required for the first electrode.

The separator material 84 is typically used to electrically insulate the second electrode 80 from the first electrode 82. The material is generally wettable by the cell electrolyte, sufficiently porous to allow the electrolyte to flow through the separator material 84, and configured to maintain physical and chemical integrity within the cell during operation. Examples of suitable separator materials include, but are not limited to, polyethylenetetrafluoroethylene, ceramics, non-woven glass, glass fiber material, polypropylene, and polyethylene. As illustrated, the separator 84 may consist of three layers, in which a polyethylene layer is sandwiched between two layers of polypropylene. The polyethylene layer has a lower melting point than the polypropylene and provides a shut down mechanism in case of cell overheating. The electrode separation is different than other lithium-ion cells in that two layers of separator are used between the second electrode 80 and the first electrode 82. Generally, the electrolyte solution can be an alkali metal salt in an organic solvent such as a lithium salt (i.e. 1.0M LiClO₄ or LiAsF₆) in a 50/50 mixture of propylene carbonate and dimethoxyethane.

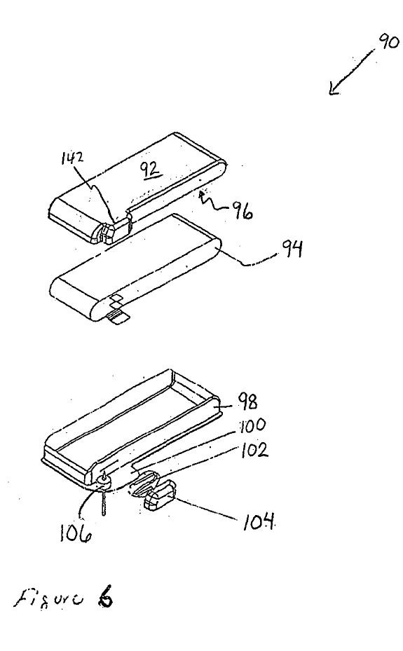

FIG. 5 illustrates an exploded view of the battery 40 shown in FIG. 3. Some of the reference numbers shown in FIG. 5 are also referenced in FIG. 3, yet have not been previously described herein. The battery 40 is shown with a coil insulator 50 that is located on an upper portion of the electrode assembly 44 when assembled. The coil insulator 50 includes slits 52 and 54 to accommodate first electrode tab 52 and second electrode tab 58 respectively, and further includes an aperture 60 to allow electrolyte to flow to the electrode assembly 44. Generally, the coil insulator 50 is comprised of ETFE (Ethylene Tetrafluoroethylene), however, it is contemplated other materials could be used such as HDPE (high density polyethylene), polypropylene, polyurethane, fluoropolymers, silicone rubber, and the like. The coil insulator 50 performs several functions including working in conjunction with an electrically non-conductive battery case liner 62 to isolate the battery case 42 and the battery cover 46 from the electrode assembly 44. It also provides mechanical stability for the electrode assembly 44.

The electrode assembly 44 is generally inserted into the case liner 62 during assembly. The case liner 62 generally extends at its top edge above the edge of the electrode assembly 44 to overlap with the coil insulator 54. The case liner 62 is generally comprised of ETFE, however, other types of materials are contemplated such as HDDE, polypropylene, polyurethane, fluoropolymers, silicone rubber, and the like. The case liner 62 generally has substantially similar dimensions to the battery case 42 except the case liner 62 would have slightly smaller dimensions so that the liner 62 can rest inside the battery case 42.

FIG. 5 further depicts features of the battery cover 46. Similar to the battery case 42, the battery cover 46 is comprised of a medical grade titanium to provide a strong and reliable weld creating a seal with battery case 42. In certain embodiments, a hermetic seal is created. It is also contemplated that the cover 46 could be made of any type of material so long as the material is electrochemically compatible. The battery cover 46 includes a feedthrough aperture 66 through which the feedthrough assembly 68 is inserted. The feedthrough assembly 68 contains a ferrule 70, an insulating member 72, and a feedthrough pin 74. The feedthrough pin 74 is comprised of niobium; however, any conductive material could be utilized without departing from the spirit of the invention. Niobium is generally chosen for its low resistivity, its compatibility during welding with titanium, and its coefficient of expansion when heated.

The feedthrough pin 74 is generally conductively insulated from the battery cover 46 by the insulated member 72, and passes through the feedthrough aperture 66 of the cover 46 through the ferrule 70. The insulating member 72, which is generally comprised of CABAL-12 (calcium-boro-aluminate), TA-23 glass or other glasses, provides electrical isolation of the feedthrough pin 74 from the battery cover 46. The pin material is in part selected for its ability to join with the insulating member 72, which results in a hermetic seal. CABAL-12 is generally corrosion resistant and a good insulator. Therefore, CABAL-12 provides good insulation between the feedthrough pin 74 and the battery cover 46 and is resistant to the corrosive effects of the electrolyte. However, other materials besides glass can be utilized, such as ceramic materials, without departing from the spirit of the invention. The battery cover 46 also includes a fill port 76 used to introduce an appropriate electrolyte solution after which the fill port 76 is sealed (e.g., hermetically) by any suitable method.

A headspace insulator 64 is generally located below the battery cover 46 and above the coil insulator 50, e.g., in the headspace above the electrode assembly 44 and below the battery cover 46. Generally, the headspace insulator 64 is comprised of ETFE; however, other insulative materials are contemplated such as HDDE, polypropylene, polyurethane, fluoropolymers, silicone rubber, and the like. ETFE is stable at the potentials of both the second electrode 80 and first electrode 82 and has a relatively high melting temperature. The headspace insulator 64 can cover the first electrode tab 58, and the second electrode tab 56, and a distal end 78 of the feedthrough pin 74. While the electrode assembly 44 is described as having first and second electrode tabs 58 and 56 respectively, it is fully contemplated each electrode could have one or more tabs without departing from the spirit of the invention. The headspace insulator 64 is designed to provide thermal protection to the electrode assembly 44 from the weld joining the battery case 42 and the battery cover 46. Such protection is provided through the introduction of an air gap between the headspace insulator 64 and the battery cover 46 in the area of the battery case 42 to cover the weld. The insulator 64 prevents electrical shorts by providing electrical insulation between the first electrode tab 58 and the second electrode tab 56. In certain embodiments, a weld bracket 79 is used to serve as the conductor between the first electrode tab 58 and the battery cover 46. In certain embodiments, the weld bracket 79 is a nickel foil piece that is welded to both the battery cover 46 and the first electrode tab 58.

The long and shallow drawn batteries 40 (and 90) of FIGS. 3 and 5 (and 6) generally include three major functional portions: (a) encasement, (b) insulation, and (c) active components. The encasement or enclosure portion includes the battery case 42 including its headspace (case 92 in FIG. 6), the battery cover 46 (100 in FIG. 6), the feedthrough assembly 68 (106 in FIG. 6), and electrical connections. The encasement generally provides a seal (e.g., a hermetic seal), a port for adding electrolyte, and isolated electrical connections. The insulators generally prevent electrical shorts. The insulators include the headspace insulator 64 (104 in FIG. 6), the coil insulator 50 (98 in FIG. 6), and the case liner 62 (96 in FIG. 6). The active components provide the electrochemistry/energy storage functioning of the battery 40 (and 90). The active components include the electrolyte and the electrode assembly 44 (94 in FIG. 6). With the batteries 40 and 90 of FIGS. 3 and 5 and FIG. 6 having similar configurations, it should be appreciated that both are equally applicable to the present invention. As such, if embodiments of the invention are described herein with respect to only one of the batteries 40 or 110, it should not be limited as such. Also, if embodiments of the invention are represented in the figures by a single tab, the invention should not be limited as such.

As described herein, an electrode assembly of a battery of the present invention includes one or more electrodes that are electrically isolated by a separator material. In certain embodiments, as illustrated in FIG. 4, the electrode assembly 44 includes first and second electrodes 82 and 80, wherein one of the electrodes is an anode and the other electrode is a cathode. The electrode assembly 44 is generally configured for even utilization of reactive material by placing the electrodes 80 and 82 in close proximity throughout the electrode assembly in the proportions in which they are utilized. As described herein, the electrodes can be represented in a variety of different configurations.

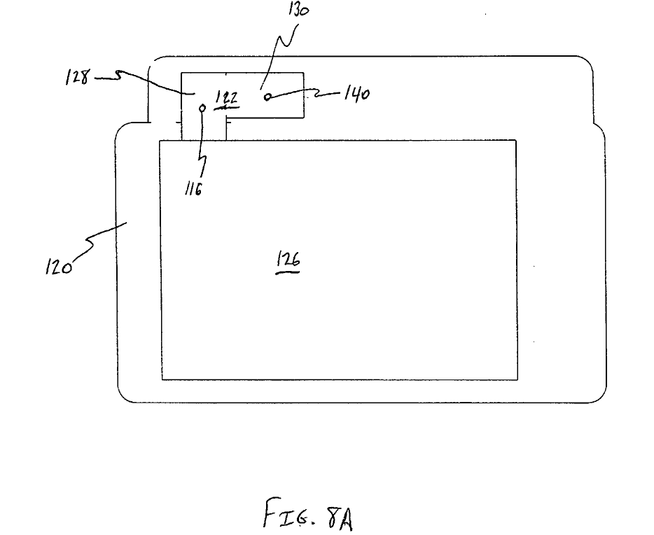

One such electrode configuration involves each of the electrodes being subdivided over one or more electrode plates connected together. In certain embodiments, as represented in FIG. 7, the electrodes 80′ and 82′ are comprised of a plurality of individual electrode plates stacked together in an electrode assembly 110. The plates are shown as generally rectangular in shape, but the invention should not be limited as such. Such plates generally have first and second major faces, and when stacked as shown, the major faces of the plates are generally stacked over each other so that the major faces align in an overlapping manner. As also represented in FIG. 7, in certain embodiments, the electrode assembly 110 is comprised of plates of each electrode being stacked together in alternating fashion—cathode electrode plate 82′, anode electrode plate 80′, cathode electrode plate 82′, anode electrode plate 80′, etc.

Each electrode plate of the electrode assembly 110 includes at least one tab 112, 114 protruding therefrom. The tabs 112, 114 generally extend out from the electrode assembly 110 so that the tabs are not covered by separator material that envelopes each electrode plate. As noted elsewhere, the separation material typically envelopes each electrode plate, and as such, at least extends proximate to the outer surface of the electrode assembly 110. In FIG. 7, tabs 112 are anode tabs extending from anode electrode plates 80′ and tabs 114 are cathode tabs extending from cathode electrode plates 82′. The tabs 112,114 protruding from the electrode plates 80′, 82′ are generally extensions of the electrode plate's current collectors and, therefore, are co-planar with their respective electrode plates.

The tabs 112, 114 are specifically located on the electrode plates 80′, 82′ so that when the electrode assembly 110 is assembled, the anode tabs 112 end up being aligned on one side of the assembly while the cathode tabs 114 end up being aligned on the opposite side of the assembly. The tabs of each electrode are coupled together to provide electrical continuity throughout the respective electrodes. The alignment of the anode tabs 112 assists with their electrical interconnection. Similarly, the alignment of the cathode tabs 114 assists with their electrical interconnection. In order to electrically interconnect a set of tabs 112 or 114, a coupling operation must be performed on them. A number of coupling techniques can be used. One exemplary technique can involve welding techniques to electrically connect the plurality of tabs for a particular electrode together. Other possible coupling techniques include, without limitation, riveting, application of conductive epoxy, connection via a conductive bridge, etc. In coupling the tabs together, electrical connection can thereafter be made to all the electrode plates of the electrode by coupling to any one of the coupled tabs.

As shown in FIG. 7, anode tabs 112 are electrically coupled at coupling point 116 and cathode tabs 114 are electrically coupled at coupling point 118. These points 116 and 118 are approximate locations on each tab 112 and 114 in the assembly 110 that may represent a welding point, a general location of multiple welding points, a rivet point, etc. to electrically interconnect a set of tabs together.

As previously mentioned herein, one of the battery electrodes is operatively coupled to a first feedthrough pin, while the other electrode is often coupled to the encasement 120 (where encasement includes its cover) or possibly a second feedthrough pin. The coupling facilitated through the use of the electrode tabs. Thereafter, when the battery is subsequently used, current is able to flow from the electrode plates through the tabs to the corresponding battery electrical contact (e.g., feedthrough pin, battery encasement). In “jellyroll” electrode assemblies, resistance spot welding individual electrode tabs to the encasement typically provides the coupling between the electrodes and the encasement. However, in electrode assemblies such as the stack of flat electrode plates shown in FIG. 7, individual electrode tabs are coupled together into a stack. Therefore, individual tabs are not readily accessible in order to weld them to the encasement. Moreover, it is difficult to weld the entire stack of tabs 112, 114 to the encasement. For instance, if one attempted to weld tabs 112 together at point 116 and to also resistance spot weld the stack of tabs 112 at point 116, a large amount of heat would be generated from such a welding in order to try and create a resistance spot weld that penetrates the stack of tabs 112 and the encasement 120. The same predicament is present when trying to weld the stack of tabs 114 to a feedthrough pin. While temperature rise is generally expected, if it is excessive, it can be problematic. Specifically, if the welding location reaches a high enough temperature, the tabs can conduct excessive heat towards the respective electrode plates. The excessive heat can potentially melt or damage the separator material insulating the electrode plates from each other. Melting or otherwise damaging the separator can short out the battery or compromise its function to the point that the battery may not be useful. Different embodiments of the present invention address this potential shortcoming.

In certain embodiments of the invention, the length of one of the tabs (e.g., a front most or rear most tab) on each electrode extends further than the other tabs to help avoid this potential negative effect on the separation material. This extended portion of the tab is welded to the encasement or the feedthrough pin in order to connect the entire electrode. Extending the tab extends the distance (along the tab) between the weld and the separator material. Therefore, any heat conducted along the tab due to the weld must travel a greater distance before reaching the separator. The heat generated by the weld has a greater chance to dissipate in the elongated tab before it reaches the separator. Accordingly, the longer tab reduces the temperature at the separator. In addition, by distancing one tab from the stack, the stack of tabs may be electrically coupled (at points 116, 118), and sometime afterwards (e.g., after the electrode assembly 110 is inserted in encasement 120) this longer tab may be individually welded to the encasement to connect the entire electrode to the encasement. By welding an individual electrode, instead of welding the entire stack, the heat required for the weld is far less. Thus, not only does the extended tab help dissipate heat generated, it permits less heat to be generated in the first place. Moreover, the complexity of manufacturing the electrode assembly 110 is reduced if much of the assembly may occur before the assembly is inserted in the encasement. It is much easier to couple tabs 112, 114 at points 116, 118 outside the encasement 120.

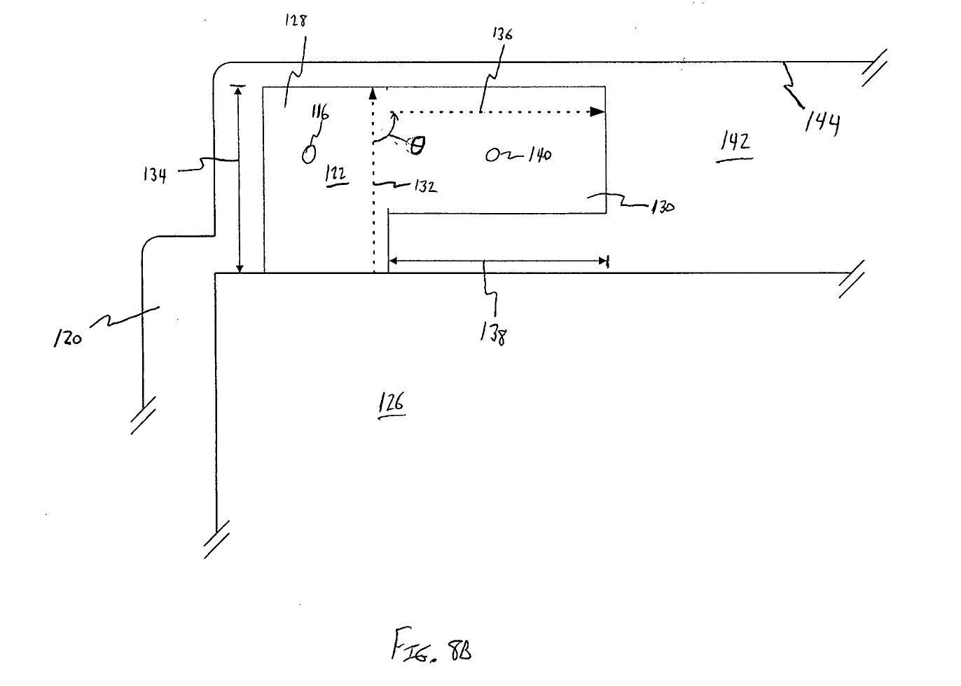

An embodiment of this design is shown in FIG. 7. Anode tabs 112 include one longer anode tab 122 and cathode tabs 114 include one longer cathode tab 124. FIG. 8A provides an isolated view of the longer anode tab 122 and its associated electrode plate 126 from the stack of such tabs 112 and plates 80′. Although the illustration focuses on an anode plate and tab, the description could apply equally to the longer cathode tab 124 and its associated electrode plate. For the sake of brevity, only the longer anode tab 122 is detailed below. As shown, electrode plate 126 includes extended tab 122 protruding therefrom. As shown more clearly in FIG. 8B, tab 122 has a first portion 128 and a second portion 130. First portion 128 protrudes in a first direction 132 from electrode plate 126 a first distance 134. Second portion 130 protrudes in a second direction 136 from first portion 128 a second distance 138. In certain embodiments, the second distance 138 is longer than the first distance 134.

Tab 122, of course, still has a coupling point 116, shown here on the first portion 128. Tab 122 also has a welding point 140 for welding the tab 122 to the encasement 120 or a feedthrough pin. With such a tab 122 configuration, welding point 140 is extended away from the separation material enveloping electrode plate 126 and the remaining electrode plates 80′ and 82′.

As noted above, the tabs extend into the headspace of the encasement. As shown in FIGS. 7, 8A, and 8B, tabs 112, 114, 122, and 124 extend into headspace 142 of the encasement 120. More particularly, tabs 112, 114, 122, and 124 extend from their respective electrode plates towards a top end 144 of headspace 142. The reference to “top” is merely arbitrary, however. The top end 144 is seen as being the end of the headspace 144 furthest from the electrode plates 80′ and 82′. Referring to FIG. 8B, the first portion 128 of extended tab 122 extends toward the top end 144 of the headspace 142. That is, the first direction is generally oriented towards the top end 144 of the headspace 142.

In embodiments where the first 132 and second 136 directions are the same or very similar, tab 122 would continue extending from its first portion 128 into the second portion 130 towards the top end 142 of the headspace 140. In order to accommodate the second portion 130, the headspace 140 would need to be extended further from the electrode plates.

However, as described herein, batteries are generally designed to be as compact as possible. One reason for keeping batteries compact is to, in turn, enable devices containing the batteries to be made as compact as possible. Given such design constraints, one may not be able to extend the tab 122 such that the first and second directions are the same or similar without increasing the headspace. That is, the battery size may need to be increased in order to accommodate such an extended tab.

While not shown, it should be appreciated that tab 122 can be folded at the junction between the first and second portions. That is, the second portion would be folded to extend across the electrode plates 80′ and 82′ outside the plane of electrode plate 126. In this manner, the welding point 140 can still be extended away from the separation material enveloping plate 126 and the amount of required headspace for the battery is not increased.

In the embodiment shown in FIGS. 8A and 8B and described above, first direction 132 and second direction 136 differ and the second portion 130 remains generally co-planar with the plate 126. In the embodiment shown, the directions differ by about 90 degrees (or 270 degrees depending on the perspective taken) as indicated by the angle θ on FIG. 8B. However, it is contemplated that the first and second directions 132, 136 may differ by between about 1° and about 179° with respect to each other. In certain embodiments, the first and second directions 132, 136 vary by between about 45° and about 135° with respect to each other. In further certain embodiments, the first and second directions 132, 136 vary by between about 75° and about 105° with respect to each other. Thus, this design provides thermal and size advantages for the battery.

By setting θ (the angle between first and second directions 132, 136) at less than or equal to 90°, it may be seen that the second portion 130 extends no closer than the first portion 128 extends towards the top end 142 of the headspace 140. Viewed from a slightly different perspective, it may be seen that second portion 130 runs no further away than does first portion 128 from the associated electrode plate 126. While these space constraints may be met without θ≦90° (e.g., using tabs of different shapes and sizes), FIG. 8B is exemplary of the spatial packaging of certain embodiments. This configuration helps conserve battery headspace by minimizing the “height” (i.e., towards the top end 142) needed to accommodate an extended electrode tab while using existing “lateral” space within the headspace 140.

In the configuration shown in FIGS. 8A and 8B, the tab first and second portions 128, 130 is shaped in the form of an “L”, with the legs of the “L” being represented by a different tab portion and the tab portions being perpendicular to each other. A wide variety of configurations (shapes) can be formed by orienting the tab portions 128, 130 in different angles with respect to each another while still accomplishing the extending and minimizing goals above.

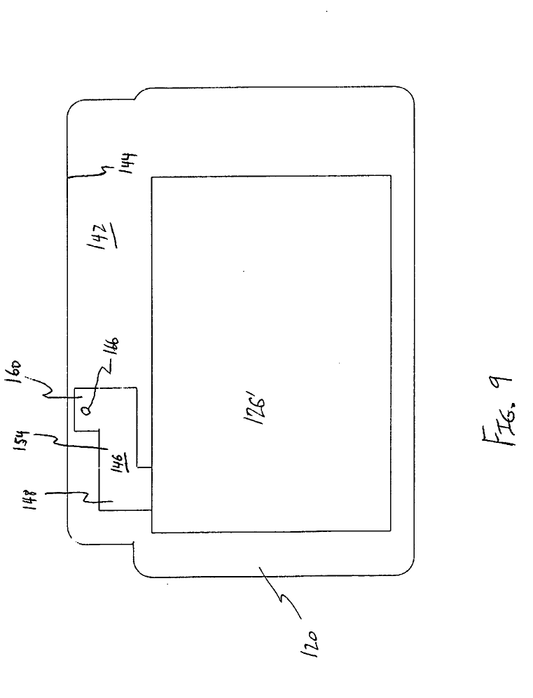

In certain embodiments, tab 122 of plate 126 could just as well be formed of three or more portions. For example, as shown in FIG. 9, electrode plate 126′ is illustrated with tab 146 having three tab portions that form a “Z” shape. Tab 146 has a first portion 148 protruding from electrode plate 126′. Tab 146 also has a second tab portion 154 protruding from the first tab portion 148. Tab 146 also has a third tab portion 160 from the second tab portion 154. Of course, third tab portion 160 could be considered a part of the second tab portion 154. In certain embodiments, the length of second portion 154 is longer than the length of either first 148 or third 160 tab portions. A weld location 166 is located on the third tab portion 160. As such, the weld location 166 can be further extended along a length of the tab 146 with the potential of being redirected from the second tab portion 154.

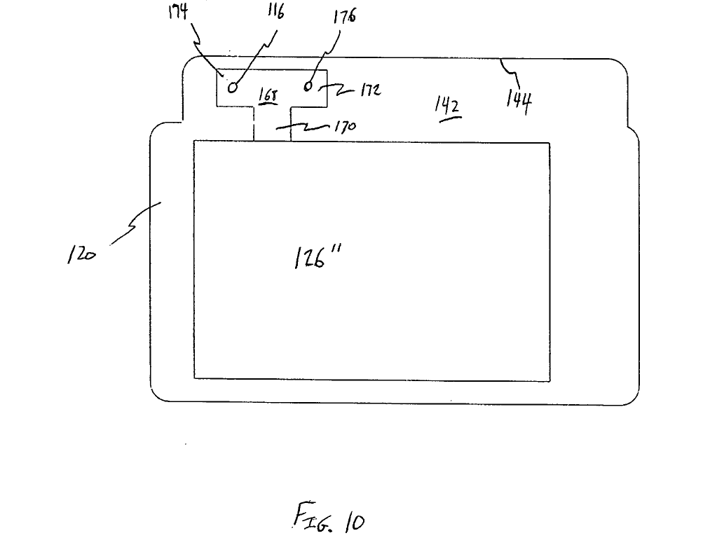

In other embodiments, two or more tab portions could each extend from the first tab portion. For example, as illustrated in FIG. 10, electrode plate 126″ is shown with tab 168 having second and third tab portions 172, 174 both extending in generally opposite directions from a first tab portion 170. Tab 168 also includes a weld location 176 on second tab portion 172 for welding to the encasement 120 or feedthrough pin and a coupling point 116 on third tab portion 174 to electrically couple with the other electrode assembly tabs. The embodiment of FIG. 10 discloses an example of extending both the weld location 176 and the coupling point further away from the associated electrode plate 126″ and its separator. That is, not only is the weld location 176 moved further away from the separator, but the coupling point 116 is distanced from the separator in case the tabs 112 are coupled together at 116 via welding or some other heat generating technique. Although the embodiment shown in FIG. 10 is described as having three tab portions, third tab portion 174 may also be considered merely as part of first tab portion 170. Thus, FIG. 10 may also be considered as having two tab portions.

The embodiment shown in FIG. 7 discloses an electrode assembly 110 formed by a stack of flat plate electrodes connected together at weld point 140 to form a separate anode and cathode. The discussion of FIGS. 8A, 8B, 9, and 10 described electrode plate 126, 126′, and 126″ as the at least one electrode plate in the flat stack having an extended tab. However, it should be understood that electrode plate 126, 126′, or 126″ may alone form the anode or cathode of an electrochemical cell. For instance, electrode plate 126, 126′, or 126″ may be wound with a second electrode plate having an extended tab (e.g., the plate holding extended tab 124 in FIG. 7) to form a “jellyroll” style winding electrode assembly 44, such as that shown in FIG. 5. Extended tabs 122 and 124 would supplant tabs 56 and 58 in FIG. 5. Also in such a configuration, coupling points 116 and 118 could be eliminated since each electrode is formed from merely a single plate. In another embodiment, the jellyroll style electrode assembly could be formed of an anode and a cathode that are each formed from multiple electrode plates electrically coupled together as described above. However, since it would be difficult to align the tabs of an electrode 112 or 114 in a jellyroll configuration, some additional bridging mechanism may be required to electrically couple the tabs of an electrode together.

It will be appreciated the present invention can take many forms and embodiments. The true essence and spirit of this invention are defined in the appended claims, and it is not intended the embodiment of the invention presented herein should limit the scope thereof.

1. An electrochemical cell for an implantable medical device, comprising:
an anode and a cathode;
a separator positioned between the anode and the cathode;
a battery case having an open end and containing an electrolyte, the separator, and the anode and the cathode;
a feedthrough pin;
a battery cover being positioned over and hermetically sealed to the open end of the battery case; and
multiple tabs each having a first portion extending from one of the anode and cathode, the first portions being electrically connected together, one of the tabs including a second portion extending away from the first portions of the tabs, the second portion mechanically coupled to one of: the battery case, the battery cover, the feedthrough pin.

2. The electrochemical cell of claim 1, wherein the first portions extend from the one of the anode and cathode generally in a first direction, the second tab portion extending generally in a second direction away from the first tab portions, and the first direction includes a different orientation from the second direction.

3. The electrochemical cell of claim 2, wherein the first and second directions differ by between about 45° and about 135°.

4. The electrochemical cell of claim 2, wherein the first and second directions differ by between about 75° and about 105°.

5. The electrochemical cell of claim 1, wherein the one of the anode and cathode is formed of multiple electrode plates.

6. The electrochemical cell of claim 5, wherein the anode and cathode are formed of multiple electrode plates stacked in alternating sequence.

7. The electrochemical cell of claim 1, wherein the one of the anode and cathode include a single plate.

8. The electrochemical cell of claim 7, wherein the anode and cathode include a plurality of plates rolled together into a jellyroll style winding.

9. The electrochemical cell of claim 1, wherein the first portions extend from the one of the anode and cathode generally towards a top end of a headspace of the battery case.

10. The electrochemical cell of claim 9, wherein the second portion extends away from the first portions no closer to the top end of the headspace than the extension of the first portions.

11. The electrochemical cell of claim 10, wherein the top end of the headspace comprises an end of the battery case furthest away from the anode and cathode.

12. The electrochemical cell of claim 11, wherein the first portions extend from the one of the anode and the cathode a first distance, the second portion extends away from the first portions a second distance, and the second distance is greater than the first distance.

13. The electrochemical cell of claim 1, wherein the first portions extend from the one of the anode and the cathode a first distance, and the second portion extends no further away from the one of the anode and cathode than the first distance.

14. The electrochemical cell of claim 1, wherein the first portions are generally aligned in an overlapping manner.

15. The electrochemical cell of claim 1, wherein the first portions of the tabs are electrically connected together via a welding.

16. An electrochemical cell for an implantable medical device, comprising:
an anode and a cathode each being formed of at least one electrode plate;
a separator positioned between the at least one plate of the anode and the cathode;
a battery case having an open end and containing an electrolyte, the separator, and the anode and cathode, a portion of the battery case defining a headspace, the headspace having a top end defined as the end of the headspace furthest away from the anode and cathode plates;
a feedthrough pin;
a battery cover being positioned over and hermetically sealed to the open end of the battery case; and
a tab extending from the at least one plate of one of the anode and the cathode into the headspace, the tab including first and second portions, the first portion extending from the one of the anode and cathode in a first direction generally toward the top end of the headspace, the second portion extending from the first portion in a second direction different from the first direction, the second portion being welded to one of the battery case, the battery cover, and the feedthrough pin.

17. The electrochemical cell of claim 16, wherein the second portion extends no closer to the top end of the headspace than the first portion extends.

18. The electrochemical cell of claim 17, wherein the first portion extends in the first direction a first distance, the second portion extends in the second direction a second distance, and the second distance is greater than the first distance.

19. The electrochemical cell of claim 16, wherein the one of the anode and cathode comprises a single electrode plate.

20. The electrochemical cell of claim 16, wherein the first and second directions lie in a plane defined by the one of the cathode and anode plates.

21. The electrochemical cell of claim 16, wherein the tab comprises a substantially “L-shaped” member.

22. The electrochemical cell of claim 16, wherein the tab comprises a substantially “Z-shaped” member.

23. The electrochemical cell of claim 16, wherein the first and second directions differ by between about 45° and about 135°.

24. The electrochemical cell of claim 16, wherein the first and second directions differ by between about 75° and about 105°.

25. The electrochemical cell of claim 16, further including at least one more tab extending from the one of the anode and cathode plates into the headspace, and the at least one more tab establishing electrical communication with the first portion of the tab.

26. The electrochemical cell of claim 16, wherein one of the anode and cathode comprises multiple discrete electrode plates.

27. The electrochemical cell of claim 26, wherein the anode and cathode are formed of multiple electrode plates stacked in alternating sequence.

28. The electrochemical cell of claim 16, wherein the one of the anode and cathode is formed of a single plate.

29. The electrochemical cell of claim 28, wherein the anode and cathode are formed of plates rolled together into a jellyroll style winding.

29. An electrode assembly for an implantable medical device, comprising:
a first electrode formed from a plurality of electrode plates;
a second electrode formed from a plurality of electrode plates, the electrode plates of the first and second electrodes being stacked in alternating sequence;
a separator located between the stacked electrode plates to prevent contact therebetween; and
a tab extending from an edge of each electrode plate, the tabs associated with the electrode plates of the first electrode being aligned in an overlapping manner in the stack and being electrically connected, the tabs associated with the electrode plates of the second electrode being aligned in an overlapping manner in the stack and being electrically connected, one of the electrode plates having a tab with a first and a second portion, the first portion extending from the edge of the one of the electrode plates in a first direction, the second portion extending from the first portion in a second direction different from the first portion, the second portion running no further away from the edge of the one of the electrode plates than first portion extends from such edge.
